(19) United States
(12) Patent Application Publication
(10) Pub. No.: US 2018/0149222 A1
(43) Pub. Date: May 31, 2018

(54) WET FRICTION MATERIAL WITH HIGHER FRICTION COEFFICIENT

(71) Applicant: Schaeffler Technologies AG & Co. KG, Herzogenaurach (DE)

(72) Inventor: Rashid Farahati, Copley, OH (US)

(21) Appl. No.: 15/745,233

(22) PCT Filed: Aug. 13, 2015
(86) PCT No.: PCT/US2015/045062

§ 371 Date: Jan. 16, 2018

(51) Int. Cl. F16D 69/02; C08L 21/02; C08L 1/02

(52) U.S. Cl. CPC F16D 69/026; C08L 21/02; C08L 1/02; F16H 45/02; C08L 2201/08; C08L 2205/16; F16D 2200/0069

(57) ABSTRACT

Friction material for a clutch pad, including fiber material and filler material including aluminum silicate. Friction material for a clutch pad, including fiber material and filler material including calcined clay. Friction material for a clutch pad, including fiber material and filler material including aluminum silicate. At least a portion of the aluminum silicate is in the form of a plurality of flakes. Each flake in the plurality of flakes is planar with an irregular boundary.

### TECHNICAL FIELD

The present disclosure relates generally to a wet friction material for clutch pads, in particular, a wet friction material with a higher friction coefficient.

### BACKGROUND

Known friction material for clutches is composed of fiber material and filler material. The fiber material forms the structure of the friction material and the filler material creates friction. Known friction material uses diatomaceous earth for the filler material. Typically, diatomaceous earth is composed of 80 to 90% silica. It is desirable to increase both static and dynamic friction coefficients for friction material. It is particularly desirable and difficult to increase the dynamic friction coefficient.

### SUMMARY

The present disclosure broadly comprises friction material for a clutch pad, including fiber material and filler material including aluminum silicate.

The present disclosure broadly comprises friction material for a clutch pad, including: fiber material and filler material including calcined clay.

The present disclosure broadly comprises friction material for a clutch pad, including fiber material and filler material including aluminum silicate. At least a portion of the aluminum silicate is in the form of a plurality of flakes. Each flake in the plurality of flakes is planar with an irregular boundary.

### BRIEF DESCRIPTION OF THE DRAWINGS

The nature and mode of operation of the present disclosure will now be more fully described in the following detailed description of the present disclosure taken with the accompanying figures, in which:

FIG. 1 is a schematic cross-sectional view of friction material including aluminum silicate;

FIG. 2 is a schematic representation of a flake of filler material;

FIG. 3 is a partial cross-sectional view of an example torque converter including the friction material shown in FIG. 1; and,

FIG. 4 is a graph plotting respective friction coefficients versus speed for known friction material and friction material including aluminum silicate.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

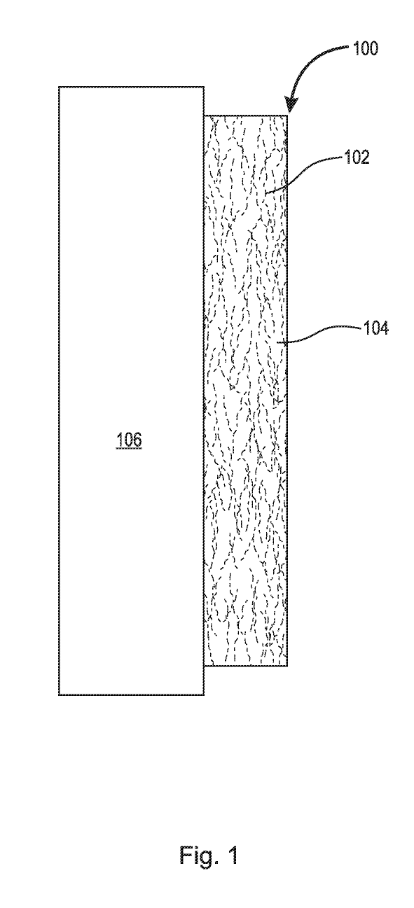

FIG. 1 is a schematic cross-sectional view of friction material 100 including aluminum silicate. Friction material 100 can be used on any clutch plate 106 known in the art.

In an example embodiment, friction material is fixedly secured to plate 106. Friction material 100 includes fiber material 102 and filler material 104 including aluminum silicate. Friction material 100 further includes binder (not shown), such as phenolic resin or latex. Fiber material 102 can be any organic or inorganic fiber known in the art, for example including but not limited to cellulose fiber or carbon fibers.

In an example embodiment, filler material 104 includes a silica-containing material other than aluminum silicate. Any silica-containing material known in the art can be used. In an example embodiment, the silica-containing material includes, but is not limited to: Celite®, Celatom®, diatomaceous earth or silicon dioxide.

In an example embodiment, friction material 100 is at least 3 percent aluminum silicate by weight and no more than 60 percent aluminum silicate by weight. In an example embodiment, friction material 100 is at least 20 percent aluminum silicate by weight and no more than 50 percent aluminum silicate by weight. In an example embodiment, the aluminum silicate has a water content of less than one percent by weight or volume.

In an example embodiment, the aluminum silicate includes calcined clay. In an example embodiment, the aluminum silicate includes calcined kaolin clay. In an example embodiment, the aluminum silicate is wholly calcined clay or wholly calcined kaolin clay.

Aluminum silicates are also interchangeably known in the art as aluminosilicates. The calcined kaolin clay has the chemical formulation of MAl₂O₃.NSiO₂, wherein M and N are integers. The exact values for M and N depend on a number of factors including the source of the raw material for the kaolin clay. In an example embodiment, the chemical composition of the calcined kaolin clay may be represented at having an alumina content of at least 35 wt % and at most 55 wt % and a silica content of at least 45 wt % and at most 65 wt %. The chemical composition of the aluminum silicate may further include trace amounts of alkaline earth oxides, for example. In an example embodiment, the chemical composition of the aluminum silicate includes at most 3.5 wt % alkaline earth oxides. In an example embodiment, the chemical composition of the aluminum silicate includes at most 1.0 wt % alkaline earth oxides. In an example embodiment, the calcined kaolin clay has a water content of less than one percent by weight or volume.

The following provides information regarding calcined kaolin clay. As those skilled in the art appreciate, a clay such as kaolin exists naturally in the hydrous form. In the hydrous form, kaolinite minerals form crystal structures that are linked together by hydroxyl containing moieties. Hydrous kaolin may be converted to calcined kaolin containing crystalline mullite and silica, for example, by thermal processes at or above 980° C.

Calcined kaolin clay can be produced from crude kaolin, coarse hydrous kaolin, or fine hydrous kaolin. As those skilled in the art appreciate, kaolin may be mined from various geographic locations including North America, Europe, and Asia. The kaolin may be subjected to preliminary processing and/or beneficiation to facilitate transportation, storage, and handling. For example, crude kaolin can be subjected to one or more of the following operations: crushing, grinding, delamination (wet milling, slurry milling, wet grinding, and the like), filtration, fractionation, pulverization, flotation, selective flocculation, magnetic separation, floc/filtration, bleaching, and the like before or after the heat treatment.

Calcination is effected by heat treating hydrous kaolin at temperatures ranging from about 500° C. to about 1300° C. or higher. In one or more embodiments, the calcined kaolin is thermally prepared at a calcination temperature of at least 1000° C. and at most 1300° C. for a time from about 1 second to about 10 hours, or at least 1050° C. and at most 1250° C. for a time from about 1 minute to about 5 hours, or at least 1100° C. and at most 1200° C. for a time from about 10 minutes to about 4 hours. In one or more embodiments, the kaolin is heated to a temperature of about 1175 to 1200° C. for a time of about 1 minute to about 2 hours. Calcined, or calcination as used herein, may encompass any degree of calcination, including partial (meta) calcination, full calcination, flash calcination, or combinations thereof.

Calcining or heat treating may be performed in any suitable manner. Heating procedures typically include soak calcining, flash calcining, and/or a combination of flash calcining/soak calcining. In soak calcining, a hydrous kaolin is heat treated at a desired temperature for a period of time (for example, from at least 1 minute to about 5 or more hours), sufficient to dehydroxylate the kaolin and form a major amount of mullite. In addition to mullite formation, in an example embodiment, the calcined kaolin clay includes crystalline polymorphs of silica, amorphous silica, or combinations thereof. In flash calcining, a hydrous kaolin is heated rapidly for a period of at most 10 seconds, typically less than about 1 second. In a flash/soak calcining operation, metakaolin is instantaneously produced during flash calcination and then processed to a finished product requirement using soak calcination. Known devices suitable for carrying out soak calcining include high temperature ovens, and rotary and vertical kilns. Known devices for effecting flash calcining include toroidal fluid flow heating devices.

In an example embodiment, friction material 100 includes least 3 percent calcined clay by total weight and no more than 60 percent calcined clay by total weight. In an example embodiment, material 100 includes: at least 20 percent calcined clay by total weight and no more than 50 percent calcined clay by total weight; about 0 to 30 percent diatomaceous earth by total weight; and about 50 percent cellulose fibers by total weight.

Example 1: material 100 includes 50 percent calcined clay by total weight, 50 percent cellulose fiber by total weight, and a latex binder.

Example 2: material 100 includes 25 percent calcined clay by total weight, 25 percent diatomaceous earth by total weight, 50 percent cellulose fibers by total weight, and a latex binder.

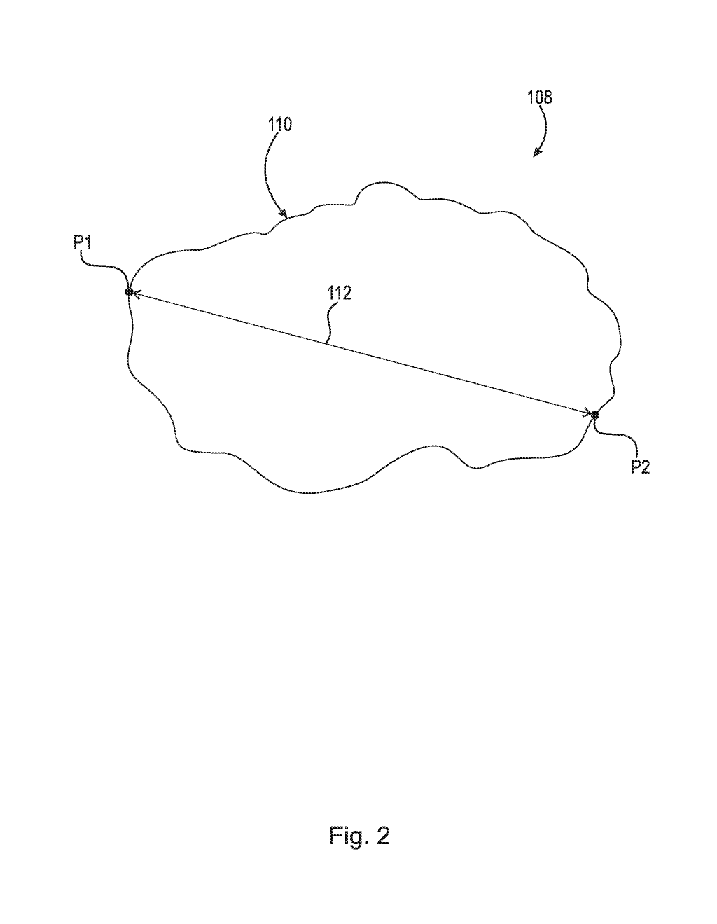

FIG. 2 is a schematic representation of flake 108 of filler material 104. In an example embodiment, at least a portion of filler material 104 is in the form of flakes 108. For example, filler material 104 includes aluminum silicate or calcined kaolin clay in the form of flakes 108. In an example embodiment, a majority of the aluminum silicate or calcined kaolin clay in filler material 104 is in the form of flakes 108. In an example embodiment, all of the aluminum silicate or calcined kaolin clay in filler material 104 is in the form of flakes 108.

Each flake 108 is substantially planar and has an irregular boundary 110. Flakes may be generally irregular or “cornflake” in geometry, or may be more lentincular or “silver dollar” type shape with smooth contours and a regular oval or round shape. For example, boundary 110 is not circular or in the form of a smooth arc(s). In an example embodiment, at least a portion of flakes 108 have respective maximum widths 112 of between 3 and 8 micro meters. In an example embodiment, a majority of flakes 108 have respective maximum widths 112 of between 3 and 8 micro meters. Maximum width 112 is formed by the longest straight line connecting two points, for example, points P1 and P2, in boundary 110.

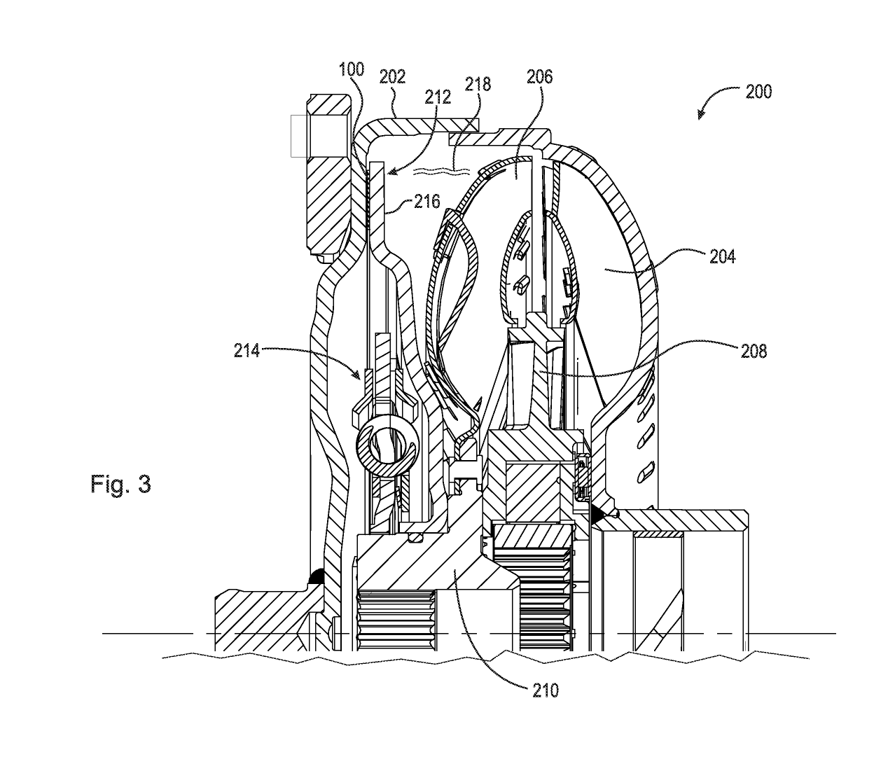

FIG. 3 is a partial cross-sectional view of example torque converter 200 including friction material 100 shown in FIG. 1. Torque converter 200 includes cover 202, impeller 204 connected to the cover, turbine 206 in fluid communication with the impeller, stator 208, output hub 210 arranged to non-rotatably connect to an input shaft (not shown) for a transmission, torque converter clutch 212, and vibration damper 214. Clutch 212 includes friction material 100 and piston 216. As is known in the art, piston 216 is displaceable to engage friction material 100 with piston 216 and cover 202 to transmit torque from cover 202 to output hub 210 through friction material 100 and piston 216. Fluid 218 is used to operate clutch 212.

Although a particular example configuration of torque converter 200 is shown in FIG. 3, it should be understood that the use of friction material 100 in a torque converter is not limited to a torque converter as configured in FIG. 3. That is, material 100 is usable in any clutch device, using friction material, for any torque converter configuration known in the art.

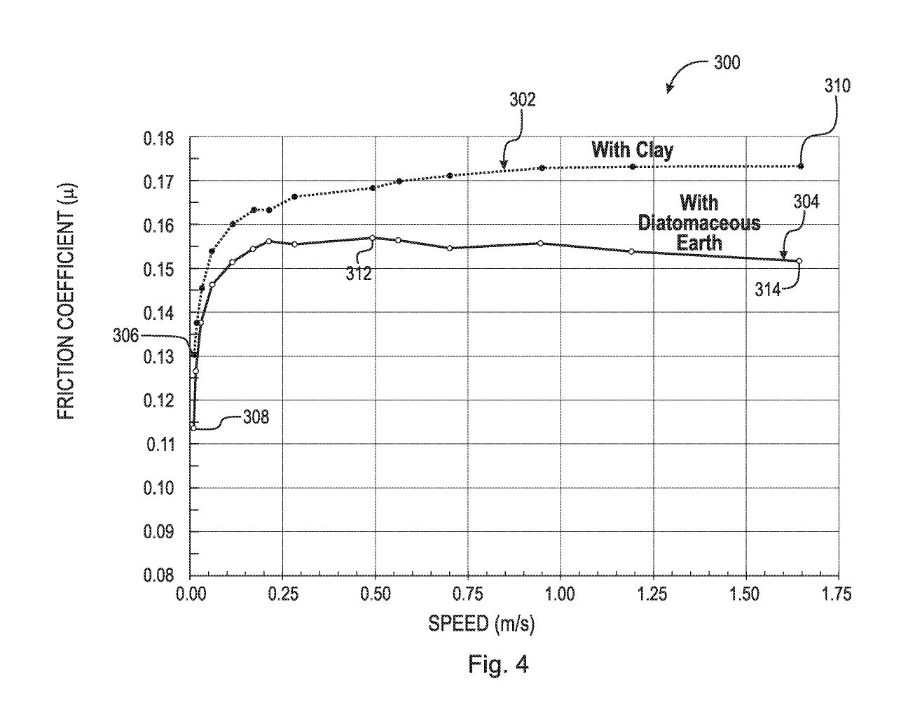

FIG. 4 is a graph plotting respective friction coefficients versus speed for known friction material and friction material 100 as formulated in Example 1 above. The speed in the x direction of the graph is the speed of the friction material with respect to a plate with which the friction material is in contact with. For example, the speed is the slip speed between the friction material and the plate. Plot 302 is for material 100 as formulated in Example 1 above. Plot 304 is for a known friction material including fiber and a diatomaceous earth filler. Plots 302 and 304 are based on actual tests of the known friction material and friction material 100. As noted above, it is desirable to maximize both static and dynamic friction for friction material for a clutch.

Advantageously, material 100 increases the static friction coefficient in comparison to known friction materials for clutches. For example for material 100, static coefficient 306 is at least 0.130 and static coefficient 308 for the known material is less, at approximately 0.114.

Regarding the dynamic friction coefficient, advantageously, the friction coefficient for plot 302 continues to increase from point 306 to point 310 at approximately 1.70 m/s. In contrast, the friction coefficient for plot 304 flattens or decreases between point 312 at 0.50 m/s and point 314 at approximately 1.70 m/s.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. Friction material for a clutch pad, comprising:
fiber material; and,
filler material including aluminum silicate.

2. The friction material of claim 1, wherein:
at least a portion of the aluminum silicate is in the form of a plurality of flakes; and,
each flake in the plurality of flakes is planar with an irregular boundary.

3. The friction material of claim 2, wherein at least a portion of the flakes in the plurality of flakes have respective maximum widths of at least 3 micrometers and no more than 8 micrometers.

4. The friction material of claim 2, wherein a majority of the flakes in the plurality of flakes have respective maximum widths of at least 3 micrometers and no more than 8 micrometers.

5. The friction material of claim 1, wherein the filler material includes a silica-containing material other than aluminum silicate.

6. The friction material of claim 1, wherein the friction material is between 3 and 60 percent aluminum silicate by weight.

7. The friction material of claim 1, wherein the aluminum silicate includes calcined kaolin clay.

8. The friction material of claim 1, wherein the aluminum silicate has a water content of less than one percent by weight or volume.

9. The friction material of claim 1, wherein the friction material has a static friction coefficient of at least 0.13.

10. Friction material for a clutch, comprising:
fiber material; and,
filler material including calcined clay.

11. The friction material of claim 10 wherein the calcined clay includes calcined kaolin clay.

12. The friction material of claim 10, wherein the friction material has a static friction coefficient of at least 0.13.

13. The friction material of claim 10, wherein the filler material includes a silica-containing material other than calcined clay.

14. The friction material of claim 10, wherein the friction material is between 3 and 60 percent calcined clay by weight.

15. The friction material of claim 10, wherein:
the calcined clay is in the form of a plurality of flakes; and,
each flake in the plurality of flakes is planar with an irregular boundary.

16. The friction material of claim 15, wherein at least a portion of the flakes in the plurality of flakes have respective maximum widths of at least 3 micrometers and no more than 8 micro meters.

17. Friction material for a clutch, comprising:
fiber material; and,
filler material including aluminum silicate, wherein:
at least a portion of the aluminum silicate is in the form of a plurality of flakes; and,
each flake in the plurality of flakes is planar with an irregular boundary.

18. The friction material of claim 17, wherein:
at least a portion of the flakes in the plurality of flakes have respective maximum widths of at least 3 micrometers and no more than 8 micrometers; or, a majority of the flakes in the plurality of flakes have respective maximum widths of at least 3 micrometers and no more than 8 micrometers.

19. The friction plate of claim 17, wherein the friction material has a static friction coefficient of at least 0.13.

20. The friction material of claim 17, wherein:
the filler material includes a silica-containing material other than aluminum silicate; or,
the friction material is between 3 and 60 percent aluminum silicate by weight.
